(19) United States
(12) Patent Application Publication
(10) Pub. No.: US 2021/0370790 A1
(43) Pub. Date: Dec. 2, 2021

(54) SYSTEMS AND METHODS FOR VOICE-ACTIVATED ELECTRIC VEHICLE SERVICE PROVISIONING

(71) Applicant: Enel X North America, Inc., Boston, MA (US)

(72) Inventor: Daniel Feldman, San Jose, CA (US)

(21) Appl. No.: 17/332,593

(22) Filed: May 27, 2021

Related U.S. Application Data
(60) Provisional application No. 63/031,349, filed on May 28, 2020.

(51) Int. Cl. B60L 53/62; B60L 53/66; B60L 53/64; B60L 53/10; G06K 9/62; G10L 15/22

(52) U.S. Cl. CPC B60L 53/62; B60L 53/665; B60L 53/64; G10L 2015/223; G06K 9/6256; G10L 15/22; B60L 53/10

(57) ABSTRACT

Systems and methods for voice-activated electric vehicle (EV) service provisioning are disclosed, wherein a user of an EV may speak a voice command corresponding to an action to be executed by an electric vehicle supply equipment (EVSE) of an electric vehicle service provisioning system (EVSPS) to charge the EV (or perform some other action). This voice command may be presented to an EVSE or an EVSE remote panel of the EVSPS. Systems and methods for training the EVSPS to recognize and act on such voice commands received via an EVSE or an EVSE remote panel are disclosed. Such voice commands may be associated with a user, a payment method, an environment of the EVSE or EVSE remote panel, etc. The EVSPS can use these trained voice commands with a plurality of EVSPS devices such that there is no need to repeat the training process with other devices of the EVSPS.

### RELATED APPLICATIONS

The present application claims the benefit of priority under 35 U.S.C. § 119(e) of U.S. Provisional Patent Application No. 63/031,349, entitled SYSTEMS AND METHODS FOR VOICE-ACTIVATED ELECTRIC VEHICLE SERVICE PROVISIONING, filed May 28, 2020, which is hereby incorporated by reference in its entirety.

### TECHNICAL FIELD

The present disclosure relates generally to the field of electric vehicle (EV) service provisioning. More particularly, systems and methods for voice-activated electric vehicle service provisioning are disclosed.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 is a system diagram for a voice-activated electric vehicle service provisioning system (EVSPS) in the context of an electrical grid system, according to an embodiment of the present disclosure.

FIG. 2 is a system diagram of the EVSPS of FIG. 1, according to an embodiment of the present disclosure.

FIG. 3 is a system diagram for an electric vehicle supply equipment (EVSE) remote panel for the EVSPS of FIGS. 1 and 2, according to an embodiment of the present disclosure.

FIG. 4 is a relational diagram illustrating associations of voice commands to EVSE functions of an EVSPS, according to an embodiment of the present disclosure.

FIG. 5 is a method diagram for an EVSPS, according to an embodiment of the present disclosure.

FIG. 6 is a method diagram for a method to voice-train an EVSPS, according to an embodiment of the present disclosure.

FIG. 7 is a relational diagram illustrating associations of voice commands to EVSE functions and environment information as used by an EVSPS, according to an embodiment of the present disclosure.

FIG. 8 illustrates an EVSPS in accordance with an embodiment of the disclosure.

FIG. 9 illustrates an EVSPS in accordance with an embodiment of the disclosure.

FIG. 10 illustrates an EVSPS in accordance with an embodiment of the disclosure.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Electric vehicles, such as full-time electric vehicles and part-time electric vehicles (or plug-in hybrid electric vehicles) (hereafter, “EV” or “EVs”) typically incorporate an onboard electrical storage and distribution system that comprises one or more batteries and a control module. The batteries of the EV may be charged by coupling the EV to electric vehicle supply equipment (EVSE). EVSE, effectively, couples the EV to an electric power source, such as an electric power grid, and may provide a command interface to permit selection of charging options and payment options. EVSE installed at a home of an owner of an EV may automate some of the tasks related to charging the EV. By way of example without limitation, a home-installed EVSE, when coupled to an EV, may identify the particular EV, select a charging mode (that may also be pre-defined by an EV owner/operator), and perform charging of the EV according to the selected charging mode. EVSE may also be installed at non-home locations, such as, e.g., public EV charging stations, fleet EV charging stations, commercial EV charging stations, etc. Use of non-home EVSE generally requires an EV operator to interact with the EVSE by means of a keypad, touch screen, or other hand-operated interface physically coupled to the EVSE, or by means of a remote application such as may be installed to a smartphone or other computing device.

The present disclosure is directed toward provisioning service to an EV (e.g., charging the EV) at an EVSE without the need for an operator to manually interact with the EVSE (other than to couple the EV to the EVSE) or a remote application. More particularly, systems and methods of provisioning service to an EV at an EVSE by means of voice commands, or voice activation, are disclosed.

Moreover, the phrases “connected to” and “coupled to” are used herein in their ordinary sense, and are broad enough to refer to any suitable coupling or other form of interaction between two or more entities, including mechanical, fluid, thermal, and magnetic interaction. Two components may be coupled to each other even though they are not in direct contact with each other. The phrase “attached to” refers to interaction between two or more entities which are in direct contact with each other and/or are separated from each other only by a fastener of any suitable variety (e.g., an adhesive, etc.).

The term “opposite” is a relational term used herein to refer to a placement of a particular feature or component in a position corresponding to another related feature or component wherein the corresponding features or components are positionally juxtaposed to each other. By way of example, a person's right hand is opposite the person's left hand.

The terms “a” and “an” can be described as one, but not limited to one. For example, although the disclosure may recite an element having, e.g., “a line of stitches,” the disclosure also contemplates that the element can have two or more lines of stitches.

Unless otherwise stated, all ranges include both endpoints and all numbers between the endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment. Not every embodiment is shown in the accompanying illustrations, however, at least a preferred embodiment is shown. At least some of the features described for a shown preferred embodiment are present in other embodiments.

The term electric vehicle (EV), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric fork lift; a cargo-carrying vehicle powered, full-time or part-time, by electricity; an off-road electrically powered vehicle; an electrically powered watercraft, etc.

The term electric vehicle supply equipment (EVSE), as used herein, refers to equipment by which an EV may be charged or recharged. An EVSE may comprise or be coupled to a computing system whereby service to the EV is provisioned, optionally, according to operator-selectable parameters. An EVSE may comprise a means of providing cost accounting, and may further comprise a payment acceptance component (for example, one or more of a card reader, a pin pad, a near field communication (NFC) reader, etc.). An EVSE may be installed at a home of an owner/operator of an EV, at a place of business for an owner/operator of an EV, at a fleet facility for a fleet comprising one or more EVs, at a public charging station, etc.

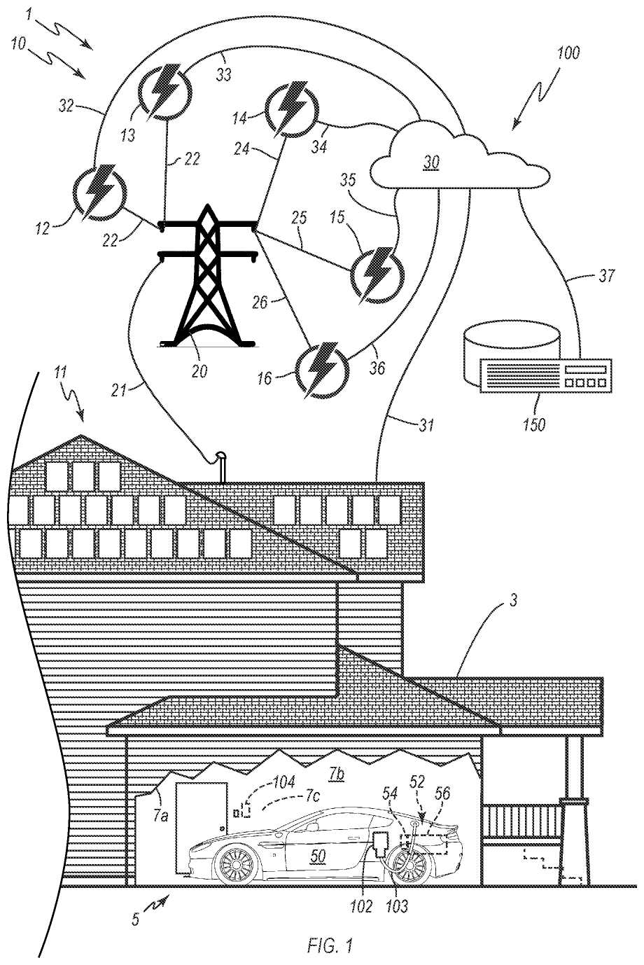

FIG. 1 is a system diagram 1 for a voice-activated electric vehicle service provisioning system (EVSPS) 100, according to an embodiment of the present disclosure, which may draw power from an electrical grid system 10. The EVSPS can be trained to recognize a voice of a user for future identification of the user at connected or otherwise associated EVSE 102. The user can then approach the EVSE 102 and couple an EV 50 for charging and then state a command such as “Hi Enel, charge my XXXX.” The EVSE locally, and/or the EVSPS remotely, identifies the user by his/her voice. The user's rights are determined (e.g., can charge, cannot charge, for how long, how much power, for what price), which may be based on the user contract (previously arranged). The method of payment for the electricity can also be determined based on the user stating how he/she wants to pay (e.g., from which pricing plan), if the EVSPS supports such options. Accordingly, the EVSPS makes the process of charging faster and easier.

The electrical grid system (hereinafter “grid”) 10 of FIG. 1 comprises a plurality of electric power sources 11-16 and a power distribution system 20. Each electrical power source (EPS) 11-16 is merely representative of possible power sources that may be part of an electrical grid system, such as the grid 10. A residence-installed solar power array 11 is shown for reference (the solar power array 11 is not required but may be present in an embodiment of the present disclosure). By way of non-limiting example, the EPS 11-16 may be one or more of a residence-installed solar power array 11, a hydroelectric power plant, a geothermal power plant, a coal-fired power plant, a wind turbine farm, a nuclear power plant, etc. No particular EPS 11-16 is required, but any one or more may be present in an embodiment of the present disclosure. Each of the EPS 11-16 may have a power transmission connection 21-26, respectively, to deliver power to a power distribution system 20. Furthermore, each EPS 11-16 may comprise computerized controls, and may have connections 31-36, respectively, to a network, such as the Internet 30, whereby load-balancing and power delivery to the power distribution system 20 may be coordinated.

The EVSPS 100 of FIG. 1 comprises an electric vehicle supply equipment (“EVSE”) 102 installed at a residential house 3. In the embodiment of FIG. 1, the residential house 3 is shown having a solar power array 11. The solar power array 11 may intermittently provide electric power to the house 3 and may also intermittently deliver electric power to the power distribution system 20 by the power transmission connection 21. The power transmission connection 21 may also deliver electric power from the power distribution system 20 to the house 3. An EV 50 is shown in a garage 5 of the house 3. The garage 5 comprises an exterior wall (partially cutaway for ease of reference) 7a and a residence-common wall 7b. The EV 50 may be a full-time electrically powered vehicle or a hybrid (part-time electrically powered) vehicle. The EV 50 comprises a power system 52, further comprising a control unit 54 and a power storage array (“batteries”) 56. The control unit 54 may serve a number of functions, such as, e.g., controlling a charge state for the batteries 56, a charge rate for the batteries 56, a charge order for the batteries 56, a charge cycle for the batteries 56, identifying the EV 50 to the EVSE 102, etc. The EVSE 102 is shown mounted at an interior portion of (a cutaway section of) the exterior wall 7a of the garage 5. The EVSE 102 is shown coupled to the EV by means of a service coupling 103. In one embodiment, the EVSE 102 may comprise a remote panel 104 that may be mounted within the house 3 and is shown in FIG. 1 mounted to an interior wall 7c of the house 3.

The EVSPS 100 may comprise a server 150. The server 150 may be a computing system, as described elsewhere herein, and may have a connection 37 to a network, such as the Internet 30. As described below, the server 150 may be in communication with the EVSE 102. With the EVSE 102 coupled to the EV 50 by the service coupling 103, the EVSE 102 may supply electrical power drawn from the solar power array 11, from the power distribution system 20, or both. The EVSE 102 may communicate with the server 150 to, among other things, employ a particular charging regime (e.g., to optimize power cost, charge the EV 50 according to a schedule, etc.), and to provide accounting for billing (and other) purposes.

While FIG. 1 illustrates a residential house 3 having a garage 5, with the EVSE 102 mounted to a wall within the garage 5, this is but one example for the EVSPS 100 and is used for convenience of the disclosure. Other examples include, without limitation, a house or other residential structure with one or more carports and one or more EVSEs, a parking structure detached from another building and having one or more EVSEs, a parking lot with one or more EVSEs, an EVSE-equipped parking place along a roadway, etc.

As previously mentioned, a user (e.g., the driver and/or owner of the EV 50) may train the EVSE 102 and/or EVSPS 100 to recognize him/her. The user may record his/her voice and train the EVSPS 100 to recognize him/her based on such recording(s). The recording of the user's voice may be accomplished via a secure means, such as a mobile device (with associated app) of the user. After training the EVSE 102 and/or EVSPS 100 to recognize the user's voice, the user may be able to approach the EVSE 102 and state a command that can be recognized by the EVSE 102, such as: “Hi Enel, charge my XXX,” where “XXX” is the nickname, or make and/or model, etc. to identify a given EV 50 associated with the user. The EVSE 102 locally or the EVSPS 100 remotely (e.g., at the server 150 or in the cloud) identifies the user by his/her voice. The user's voice may be recognized utilizing a proprietary or provider-based voice recognition library. If the identification of the user is accomplished locally by the EVSE 102, then EVSE 102 may send a message to the EVSPS 100 to let it know a specific user was identified. The EVSPS 100 can determine the user rights (e.g., can charge, cannot charge, for how long, how much power, for what price), which may be based on a user agreement or contract that may have been previously put in place. In certain embodiments, the user may utilize one or more voice commands to instruct the EVSE 102 on a preferred payment methodology (e.g., from which pricing plan) that may be desired.

The combination of these foregoing features and elements allows ease and convenience at an EVSE 102—e.g., a plug and charge experience not presently available—that can improve the entire process of charging. For example, charging the EV 50 with EVSE 102 in a public place can be faster and easier. Charging the EV 50 with EVSE 102 at home can also be simplified through easier vehicle identification during home charging (e.g., a command can be simply “Hi Enel, charge my XXX now (when outside time-of-use)). Time-of-use (“TOU”) in this command may refer to a method of measuring and charging for energy consumption based on when the energy is used. For example, utility companies charge customers more for energy consumption during the time of day when electricity use is higher. TOU rates vary by region and utility.

Stated otherwise, the user can speak directly to the EVSE 102 to initiate, configure, and otherwise control provisioning service (e.g., charging, stopping charging, scheduling charging, configuring charging (e.g., time, power, etc.), unlock the EVSE 102, lock the EVSE 102, etc.). The user can view on the connected EVSE 102 (or otherwise obtain) a state of charge of the EV 50 and, for example, tell the EVSE 102 to “Add ‘x’ kWh.” While presently available systems may enable configuration and providing commands via an application on a separate mobile device, these systems can be cumbersome and awkward to use because they require separate steps of plugging in the EV and then fumbling with the mobile device. These systems may require a specific physical operation on the mobile device, which precludes a user from performing authentication while holding the cable to connect to and charge the car. The cable is heavy, and these other physical operations may require two hands. The presently disclosed embodiments can enable the user to authenticate via voice recognition without use of their hands and while grasping, for example, the charging cable of the EVSE 102.

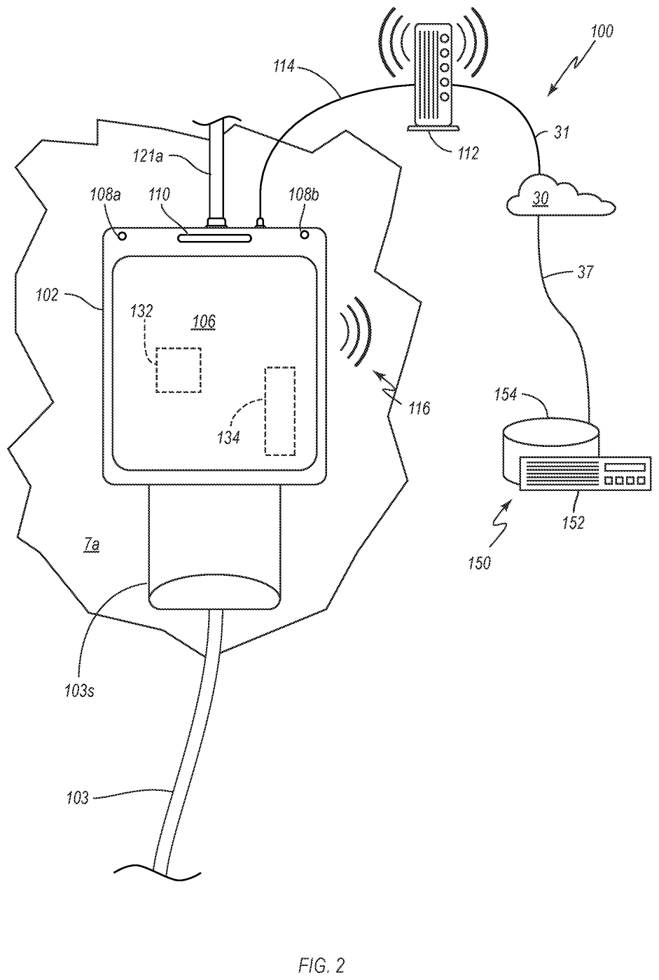

FIG. 2 is a system diagram of the EVSPS 100 of FIG. 1, according to an embodiment of the present disclosure. The EVSE 102 is shown mounted to a portion of the wall 7a. In some embodiments, the EVSE 102 may be otherwise mounted, for example, to a stanchion, a pole, a collective EVSE mounting system, etc. A power supply connection 121a is coupled to the EVSE 102 and provides electrical power to the EVSE 102. The electrical power carried by the power supply 121a may be 30 amperes (amps) or more, and is sufficient to permit the EVSE 102 to power any onboard electronics and to provide charging service to a connected EV (see the EV 50 in FIG. 1). The EVSE 102 comprises a storage portion 103s to store the service coupling 103 when the service coupling 103 is not in use, or when the service coupling 103 need not be fully extended to service an EV. The EVSE 102 further comprises a user interface 106. In at least one embodiment, the user interface 106 may comprise or define a touch screen. The EVSE 102 may comprise a microprocessor 132 and a storage system 134. The microprocessor 132 may be a purpose-built computing processor capable of executing machine-executable instructions. The storage system 134 may comprise a non-volatile storage medium such as described below and may be capable of storing machine-readable and -executable instructions. The EVSE 102 comprises two microphones 108a, 108b capable of registering sounds generally within the range of human vocal production. In some embodiments, the EVSE 102 comprises one microphone, and in some embodiments, the EVSE 102 may comprise more than two microphones. A multiple-microphone embodiment may be preferable to a single-microphone embodiment in order to, for example, facilitate isolating human vocal audio from other audio such as background noise. The EVSE 102 may further comprise at least one speaker 110 capable of producing sound in the human hearing range, and, more particularly, sounds at least similar to human vocal articulation (speech).

The EVSE 102 may comprise a physical connection 114 to a network router/gateway 112. The EVSE 102 may comprise a wireless connection 116 to the network router/gateway 112. The network router/gateway 112 may have a connection 31 to a network, such as the Internet 30. The EVSE 102 may communicate via the physical connection 114 and/or the wireless connection 116 through the router/gateway 112 and the Internet 30 with the server 150. The server 150 comprises at least a computing system 152 and a storage system 154. The computing system 152 may be a purpose-built or purpose-configured computer capable of receiving, executing, and sending machine-executable instructions, and capable of receiving, manipulating, and sending machine-readable data. The storage system 154 may comprise non-volatile memory as described below and be capable of storing both machine-readable data and machine-executable instructions.

The EVSE 102 may be configured to accept input at the user interface 106, and to provide output (display information) at the user interface 106. The EVSE 102 may be configured or configurable to accept human voice input via the microphone(s) 108a, 108b, and may also be configured or configurable to render audio output via the speaker 110. The EVSE 102, when configured to accept human voice input, may be capable of performing at least some of the methods described in conjunction with FIGS. 5, 6, and 7. Simply stated (and more fully described below), a user may interact with the user interface 106 to initiate a training session whereby the user receives visual and/or audio instructions to provide particular audio input that the EVSPS 100 may associate with one or more particular functions related to charging the EV 50 at the EVSE 102. Once at least one function has been associated with the particular audio input of the particular user, the same user may thereafter use the same audio input to cause the EVSPS 100 to perform the associated function, such as, e.g., to charge an EV 50 connected to the EVSE 102 using a preselected charging plan. In addition to associating a particular EVSE function to a particular voice command of a particular user, the association may comprise relation to a particular EV.

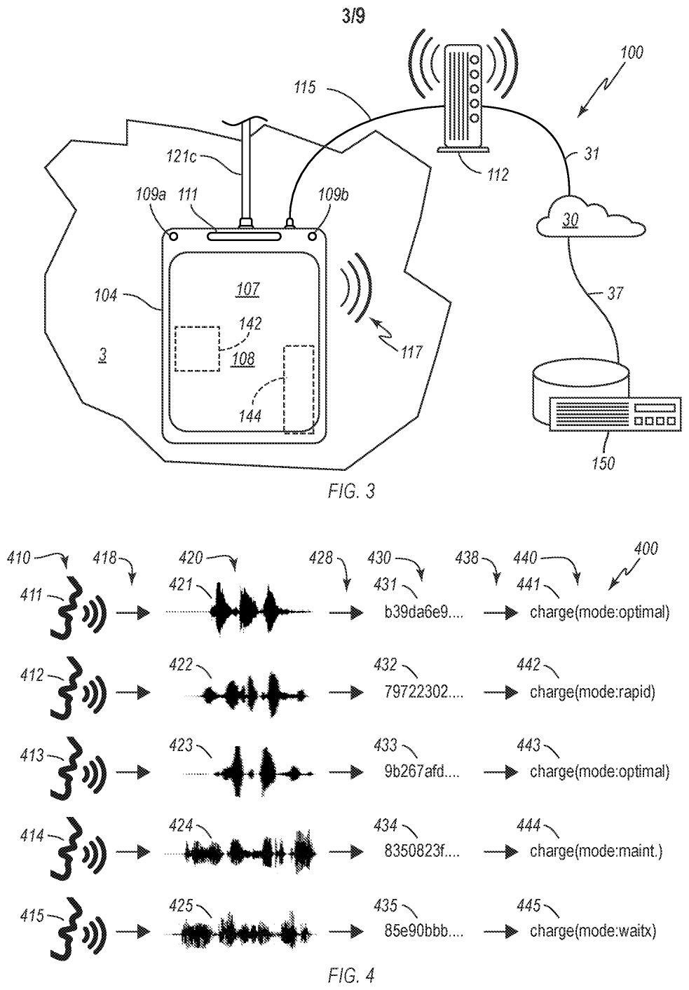

FIG. 3 is a system diagram for an EVSE remote panel 104 for the EVSE 102 of the EVSPS 100 of FIGS. 1 and 2, according to an embodiment of the present disclosure. The EVSE remote panel 104 may be mounted, for example, at an interior wall of a building, such as the house 3 of FIG. 1. A power supply connection 121b is coupled to the EVSE remote panel 104 and provides electrical power to the EVSE remote panel 104. The electrical power carried by the power supply 121a may be 30 amps or less, and is sufficient to permit the EVSE remote panel 104 to power any onboard electronics. The EVSE remote panel 104 may comprise a microprocessor 142 and a storage system 144, which may be configured to operate similar to the microprocessor 132 and storage system 134 of the EVSE 102. The remote panel 104 may comprise a user interface 107 similar to the user interface 106 of the EVSE 102, and may comprise one or more microphones 109a, 109b and a speaker 111, each of which may function at least similarly to the microphone(s) 108a, 108b and speaker 110 of the EVSE 102. The remote panel 104 may have a physical connection 115 and/or a wireless connection 117 to a router/gateway 112. The physical connection 115 and/or wireless connection 117 may permit the remote panel 104 to communicate with the EVSE 102. Furthermore, the router/gateway 112 have the connection 31 to the Internet 30 and then to the server 150 (by way of the connection 37). The remote panel 104 may be configured to communicate with the server 150 in much the same way as the EVSE 102. The remote panel 104 may permit a user to perform voice command training of the EVSPS 100, or to provide voice command inputs to the EVSPS 100 as though the user were using the EVSE 102.

FIG. 4 is a relational diagram illustrating associations of voice commands 410 to EVSE functions 440 of an EVSPS 400, which may be similar in many respects to the EVSPS 100 of FIGS. 1-3. A user speaks a voice command 410, and a microphone (see microphones 108a, 108b of FIGS. 2, and 109a, 109b of FIG. 3) receives 418 the command. The command may be recorded as a waveform 420. The waveform may be processed 428 to convert it to a digital signature 430. The digital signature may be associated 438 to an EVSE function 440. In one embodiment, a particular digital signature may be associated 438 to a collection of EVSE functions 440.

A first user speaks a command 411 that a microphone 108a, 108b receives 418 and records as a digital waveform 421. The digital waveform 421 may be converted 428 to a digital signature 431, that is associated 438 with a particular EVSE function 441. The voice command 411, in the present example, may be associated with an EVSE function 441 to charge the connected EV using an optimal cost algorithm. The first user may further speak a second command 412 that produces a waveform 422 distinct from the waveform 421, and that results in digital signature 432 different from the digital signature 431, and that is associated to an EVSE function 442 different from the associated EVSE function 441 of the voice command 411, for example, to charge the connected EV rapidly.

A third voice command 413 may extend the present example for the first user, or may provide an example for a second user. In the former instance, the first voice command 411 may include an identifier for a particular EV, or for a particular EVSE. The voice command 413 may likewise include an identifier for a different EV, or for a different EVSE. As such, the voice command 413 produces a waveform 423 distinct from the waveforms 421 and 422, resulting in a digital signature 433 different from the digital signatures 431 and 432, and associated to a command 443 which is distinct from the command 442, and distinct from the command 441 by an indication of a second particular EV or second particular EVSE. In the latter instance, a second user speaks a voice command 413 comprised of the same words/phrases as the first voice command 411. A waveform 423 is produced for the second user that is distinct from the waveform 421 of the first user for the same command. A resulting digital signature 433 for the second user is likewise distinct from the digital signature 431 of the first user. The command associated 443 with the digital signature 433 may be identical to the command associated 441 to the digital signature 441. In the latter example, the EV may be used by two (or more) users and (at least) two of the users have trained the EVSPS 400 to provide the same EVSE function, e.g., charge the EV 50 using the optimal plan. In yet another example, the command associated 443 with the digital signature 433 (and, hence, the voice command 413) may be associated to a different EV than is the command associated 441 with the digital signature 431. This may ensure that a voice command of a particular user results in EVSE functions being performed for that particular user, including, for example, only to charge the EV of the particular user, to provide accounting functions for the particular user and EV, etc.

Similarly voice commands 414, 415 may be spoken by the same or different users, each producing a unique corresponding waveform 424, 425 and resulting in distinct corresponding digital signatures 434, 435 that are associated with particular EVSE functions 444, 445.

Distinctly training each command for each user, optionally along with an associated EV, may permit a wide variety of voice command functionality. By way of non-limiting example, an owner of an EV may train an EVSPS, according to an embodiment of the present disclosure, to perform a variety of functions, and may further cause the EVSPS to be trained to perform one EVSE function or a limited set of EVSE functions. The owner in the present example may be able to train and use voice commands to permit any charging mode available to the EVSPS, while a spouse or child may be limited to only using an optimal charging mode. Similarly, in a fleet setting, one level of employee-user may be able to use voice commands to perform limited EVSE functions, e.g., optimal charging mode, while another level of employee-user may have access to additional EVSE functions, e.g., battery maintenance cycle, etc.

FIG. 5 is a method diagram for an EVSPS 500 that is at least similar in many respects to the EVSPS 100, 400 of, respectively, FIGS. 1-3 and FIG. 4. At any point in the lifecycle of the EVSPS 500, the EVSPS may be voice-trained and voice-enabled, voice-trained and not voice-enabled, or not voice-trained. If a determination 502 is made that the EVSPS 500 has not 503 been voice-trained, the EVSPS 500 enters or remains in a mode of non-voice input 563. If the yes 504, the EVSPS 500 has been voice-trained, then a determination 506 follows whether the EVSPS 500 is voice-enabled. If no 507 (not voice-enabled), the EVSPS enters or remains in the non-voice input mode 563. If yes 508 (voice-enabled), the EVSPS 500 enters a listening mode wherein the microphone(s) (see the microphones 108a, 108b, 109a, 109b in FIGS. 2 and 3) may be enabled. The EVSPS 500 may acquire audio input 511 via the microphones and convert 513 the audio input to a digital signal. The digital signal may be processed 515. Processing the digital signal may comprise elimination of background noise and application of appropriate audio filters in an effort to isolate a human voice signal, if such a human voice signal is present. If a human voice signal is present, the EVSPS 500 determines 517 if an EVSPS alert component is present. If the EVSPS 500 determines 517 that no alert signal is present 519 (including if no human voice signal is present), the EVSPS 500 continues to listen to acquire an audio input 511.

If an alert signal is present (yes) 521, the EVSPS 500 determines 523 whether the human voice signal represents a known user. The EVSPS 500 may be configured to identify a known user by isolating the alert signal and digitally processing the alert signal to develop a digital signature that is then compared to a catalog of alert signal digital signatures stored in a memory of a storage system of the EVSPS 500. In one embodiment, the catalog of alert signal digital signatures (as well as any other digital signature catalogs) may be partitioned into digital signature sub-catalogs associated with a known geophysical region. By way of example without limitation, the EVSPS 500 may compare the current digital signature input to digital signatures previously acquired at the particular EVSE and digital signatures previously acquired at EVSEs within a particular distance of the current EVSE, e.g., within a radius of the current EVSE representing possible travel distances of EVs to the current EVSE. If the EVSPS 500 does not find a match for the current digital signature, the EVSPS 500 may extend the comparison search to include a next distance tier of EVSEs from the current EVSE, and may continue to do so until finding a matching digital signature, or reaching a distance threshold that removes distance limitations to permit searching the entire catalog of alert signal digital signatures.

If the EVSPS 500 determines 523 that the alert signal digital signature does not represent a known user (no) 525, the EVSPS 500 may require non-voice input 563 in order to proceed further. If the alert signal digital signature is determined 523 to represent a known user (yes) 527, the EVSPS 500 determines 529 whether the human voice signal comprises an associated EVSE function command. The EVSPS 500 isolates the alert signal from the human voice signal and generates a candidate command digital signature of the remaining signal, then compares the candidate command digital signature with a catalog of digital signatures of voice commands previously associated with the known user. If the EVSPS 500 determines that the candidate command digital signal does not match a previously associated command for the current user (no) 531, the EVSPS 500 may visually display at a user interface and/or audibly render one or more options 555. The options 555 may include a prompt to repeat the command 557, a prompt to exit from voice command mode 559, an option to train a command not previously associated 561, etc. The EVSPS 500 may enter a wait state wherein the EVSPS 500 returns to listening to acquire an audio input 511. In one embodiment, the EVSPS 500 may also display on the prompts to a user interface whereby the user may press a button or otherwise physically signal a choice from the available options. If an audio input is not acquired (or a selection input is not provided or otherwise made at the user interface) within a timeout threshold, the EVSPS 500 may exit the wait state and continue listening for an audio input 511. During the wait state, the EVSPS 500 may be configured to accept an exit command from the known user to dismiss the wait state. If the training prompt 561 is selected or entered, the EVSPS 500 may enter a training mode 579. If any other audio input is acquired 511, the EVSPS 500 may repeat the foregoing steps to identify whether the human voice signal comprises an associated EVSE function command 529.

If the EVSPS 500 determines 529 that an associated EVSE function command is present (yes) 533, the EVSPS 500 determines whether the associated EVSE function command requires an EV coupled to the EVSE 535. If an EV is not required to be coupled to the EVSE (no) 537, the EVSPS 500 executes the associated command(s). If an EV, or a particular EV, must be coupled to the EVSE for the associated command(s) (yes) 539, the EVSPS 500 may determine 541 if the EV is coupled to the EVSE. If the EV is not coupled (no) 543, the EVSPS may cause the EVSE to display or audibly render 551 a prompt to connect the EV 553. The EVSPS 500 may iteratively repeat the check to determine a connection of the EV to the EVSE and prompt 551 for the connection. The EVSPS 500 may be configured to execute a particular number of iterations, or reiterate for a particular time and, upon reaching the configured threshold, perform a timeout 581 and return to listening for an audio input 511. If the EVSPS 500 determines the EV is connected (yes) 545, the EVSPS 500 may execute the associated command(s).

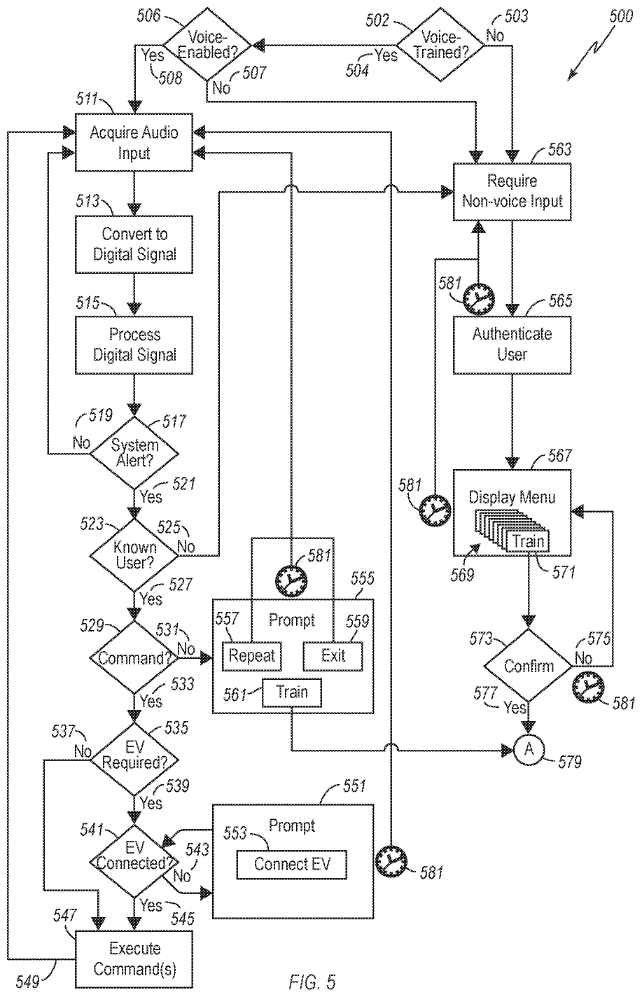

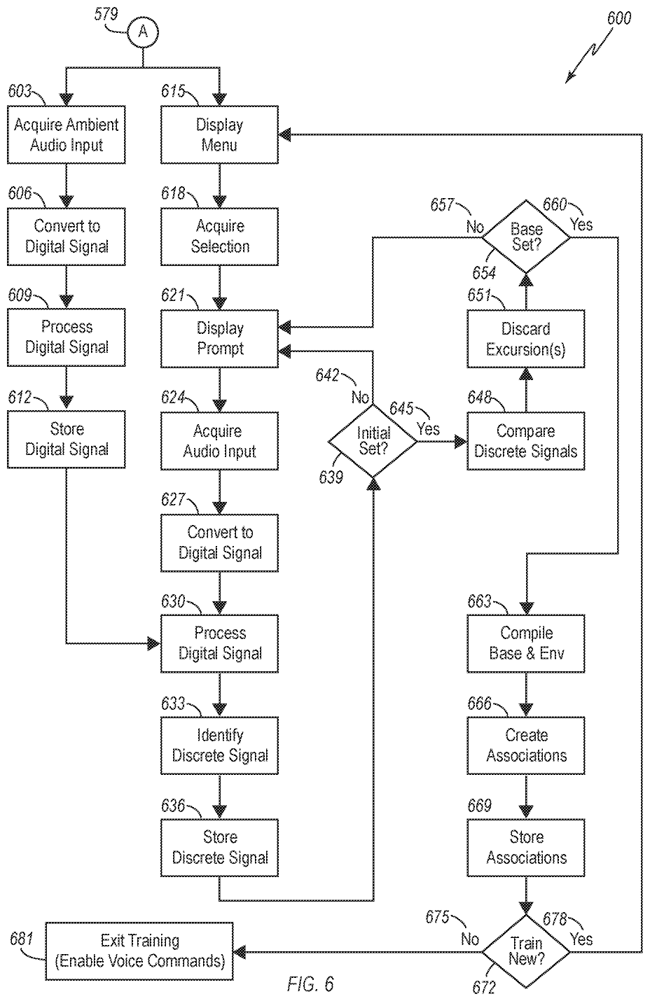

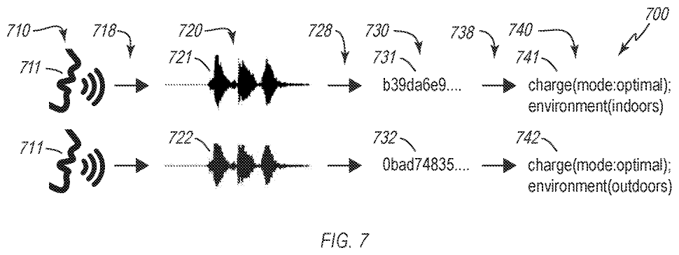

When the EVSPS 500 is in non-voice input mode 563, a user authentication may be required 565. User authentication may be performed at an EVSE user interface, at an EVSE remote panel interface, or via an application installed to a computing device (such as a smartphone). The EVSPS 500 may reach a timeout threshold 581 while waiting for user authentication, whereupon the EVSPS 500 may return to waiting for non-voice input 563. When a user is authenticated 565, the EVSPS may render 567, at the user interface, a selection menu comprising 569 a number of options. The user may select 571, an option to place the EVSPS 500 into training mode. Similarly, the user may select an option to enable/disable voice commands. When the user selects 571 to place the EVSPS 500 in training mode, the EVSPS 500 may prompt 573 for confirmation to enter training mode. This may be useful in a situation wherein the user inadvertently selected to enter training. If the user does not confirm training mode (no) 575, or if the EVSPS 500 reaches a timeout threshold 581 before receiving input, the EVSPS 500 returns to waiting for non-voice input 563. If the user confirms training (yes) 577, the EVSPS 500 enters 579 training mode. Training mode is described in conjunction with FIG. 6.

FIG. 6 is a method diagram for a method to voice-train an EVSPS 600, according to one embodiment, that may be similar in many respects to the EVSPS 100, 400, 500 of FIGS. 1-3, 4, and 5. The EVSPS 600 may enter or otherwise acquire 579 a training mode as described previously in conjunction with FIG. 5. With the EVSPS 600 in a training mode, the EVSPS 600 may acquire 603, by means of the microphone(s) (see the microphones 108a, 108b, 109a, 109b in FIGS. 2 and 3), an ambient audio input, convert 606 the ambient audio input to a digital signal, and process 609 the digital signal. Processing the digital signal 609 may involve application of filters, audio compression, analysis, etc., to establish a digital signature for ambient noise of the environment in which the EVSE is situated. The digital signature may be stored 612, for example, at a local storage system of the EVSE or at a storage system remote to the EVSE (see the EVSE storage system 134, the EVSE remote panel storage system 144, and the EVSPS server storage system 154 of FIGS. 2 and 3).

In parallel to acquiring the ambient audio input 603, through storing the ambient audio digital signal 612, the EVSPS 600 may visually display 615 a menu of options available during training. Options may include to remove (a) previously trained voice command(s), to exit the training mode, and to select one or more commands for training to voice command(s). The user may select one or more selections indicating command(s) to train to the voice command(s) and the EVSPS 600 may receive or otherwise acquire 618 the user's selections indicating the command(s) to train to the voice command(s). The EVSPS 600 may display 621 instructions that may comprise a prompt of a word or phrase for the user to speak. When the user speaks the word or phrase, the EVSPS 600 may acquire 624 an audio input of the spoken word or phrase. The EVSPS 600 may convert 627 the audio input to digital signal and process 630 the digital signal. Processing 630 the digital signal may include use of one or more filters, compression of the audio signal, analysis, etc., and includes use of the ambient audio digital signal to identify 633 a discrete signal attributable as the spoken word or phrase. It is noteworthy that an EVSE or EVSE remote panel of the EVSPS 600 may enter a voice command mode (as described in conjunction with FIG. 5) without having been previously used in either a voice command mode or a voice command training mode. By way of non-limiting example, an EVSE remote panel may be used to train the EVSPS 600, and an associated EVSE may subsequently enter a voice command mode. The EVSPS 600 may perform the method steps of 603-612, inclusive, to identify ambient noise for the particular input system (EVSE, EVSE remote panel, etc.) to acquire the local ambient noise in order to filter out the local ambient noise so as to identify a discrete voice command, where the discrete voice command is a signal representing the voice command with ambient audio removed.

This discrete signal may be stored 636, preferably at the local storage system. For example, the discrete signal may be stored 636 at the EVSE storage system 134 in FIG. 2 if the user is using an EVSE to train the EVSPS 600, at the EVSE remote panel storage system 144 in FIG. 3 if the user is using an EVSE remote panel to train the EVSPS 600, or at an onboard storage system of a device (such as a smartphone) if the user is training the EVSPS 600 via such a device.

The EVSPS 600 may then determine 639 whether an initial set of discrete signals has been acquired. The EVSPS 600 may, for example, determine that a number of discrete signals have been generated as described above. The EVSPS 600 may determine 639 whether the number (or quantity) of discrete signals can constitute an initial set, such as by comparing that number to a threshold. The threshold may represent the number of discrete signals that is to be used in a base set of discrete signals, where a base set of discrete signals is a plurality of discrete signals for the current training session that can be compared to identify a unique digital signature and/or digital signature envelope for the current voice command. When the EVSPS 600 determines 639 an initial set has not been acquired (no) 642 according to this threshold, the EVSPS 600 may iterate through the method steps 621-639 until an initial set is acquired, according to this threshold.

When an initial set according to the threshold has been acquired (yes) 645, the EVSPS 600 may compare 648 the discrete signals of the initial set to determine if any unacceptable excursions exist. An excursion is a discrete signal in the initial set that varies significantly from one or more of the other discrete signals in the initial set, such that a meaningful digital signature or digital signature envelope cannot be established using the discrete signals found in the initial set. Such excursions may be discarded 651 from the initial set. As can be appreciated, in some instances, the initial set does not include any excursion.

The EVSPS 600 then determines 654 if the discrete signals of the initial set can be considered a base set. For example, the EVSPS 600 may check whether the number of discrete signals of the initial set still meets the threshold for a base set. If, for example, no excursions were found in (and removed from) the initial set, the discrete signals of the initial set may be considered a base set. If the base set does not exist (no) 657 (e.g., because excursions were removed from the initial set such that the number of discrete signals in the initial set no longer meets the threshold), the EVSPS 600 again iterates through the method steps 621-639 to acquire additional discrete signals for an initial set, and subsequently checks for a base set (and this process may be repeated as necessary until a base set exists). If a base set exists (yes) 660, the EVSPS 600 may compare the discrete signals of the base set and compile 663 a digital signature base and digital signature envelope for the current voice command.

The EVSPS 600 may associate 666 the current digital signature base and envelope with the command(s) selected 618 by the user. The association is stored 669. The association may comprise the digital signature base and envelope, the selected command(s), and any parameters the selected command(s) may accept. By way of example without limitation, a user may select 618 to train the EVSPS 600 to charge a first EV employing an optimal charging plan based on regional power distribution costs, and to associate those costs to a particular form of payment. In this instance, the association may comprise the digital signature base and envelope for the current user and voice command, an identifier of the first EV, a set of machine-readable instructions that may be used to invoke the EVSE charging function that employs parameters for optimal cost charging, and an identifier for the selected form of method of payment.

With the association for the current command stored, the EVSPS 600 may present 672 an opportunity to train an additional command(s). If no additional training 675 is elected by the user, the EVSPS 600 may exit 681 the training mode. If the user elects to train an additional voice command (yes) 678, the EVSPS 600 may iterate again through the training, commencing with displaying 615 the menu of available options.

In one embodiment, the EVSPS 600 performs the training method locally. In other words, if the user is at an EVSE 102, the training method is employed at the EVSE 102, with the resulting command associations propagated from the EVSE 102 to the EVSPS server (e.g., the digital signature and an indication of the associated command may be sent to the server). This may permit the owner of the EV 50 to use the same voice command, without retraining, at another EVSE or EVSE remote panel associated with the EVSPS 100. Further, by way of example, without limitation, and with reference to FIGS. 1 and 6, the owner of the EV 50 may elect to train the EVSPS 100 from the EVSE remote panel 104. The training method of FIG. 6 may be employed at the EVSE remote panel 104. When a voice command has been successfully trained at the EVSE remote panel 104, the association may be propagated to the EVSE 102 and to the EVSPS server 150 (e.g., the digital signature and an indication of the associated command may be sent to one or both of the EVSE and the server). This manner of training may permit the owner of the EV 50 to use the same voice command, without retraining, at the EVSE 102, or at another EVSE or EVSE remote panel associated with the EVSPS 100. In other words, the training performed at the EVSE 102 or the EVSE remote panel 104 may allow the user to employ the same voice command at the EVSE 102 (e.g., a home EVSE), the EVSE remote panel 104 (e.g., a home EVSE remote panel) or at another EVSE or EVSE remote panel that is (also) associated with the EVSPS 100 that may be located, e.g., at his/her place of employment, at a public parking structure, etc., all without necessitating training at the particular EVSE/EVSE remote panel.

FIG. 7 is a relational diagram illustrating associations of voice commands 710 to EVSE functions and environment information 740 as used by an EVSPS 700, which may be similar in many respects to the EVSPS previously described herein. A user speaks 710 a command (similarly to commands previously described herein), and one or more microphones (see the microphones 108a, 108b of FIG. 2; 109a, 109b of FIG. 3) receive 718 the command. The command may be recorded as a waveform 720. The waveform may be processed 728 to convert it to a digital signature 730.

The digital signature may be associated 738 to an EVSE function and environment 740. In one embodiment, a particular digital signature may be associated 738 to a collection of EVSE functions and an environment 740.

An example of environment association as used by the EVSPS 700 is now described. A first user that is in an indoor environment speaks a command 711 that one or more microphones of an EVSE or an EVSE remote panel (see 108a, 108b; 109a, 109b in FIGS. 2, 3) of the EVSPS 700 receives 718 and records as a digital waveform 721. The digital waveform 721 may be converted 728 to a digital signature 731. The digital signature 731 can be associated 738 with an EVSE function to charge a connected EV using an optimal cost algorithm, and the digital signature may correspond to the indoor environment where the user is located 741. In other words, the voice command 711 was given while the user was in an indoor environment, and the acoustics of this indoor environment had at least some effect on the digital waveform 721 and the subsequent digital signature 731 that are generated.

As a second example of environmental association used by the EVSPS 700, the (same) first user can be relocated to an outdoor environment and may speak the (same) command 711 that a microphone of an EVSE or an EVSE remote panel (see 108a, 108b; 109a, 109b) receives 718 and records as a digital waveform 722. The digital waveform 722 may be converted 728 to a digital signature 732. The digital signature 732 may be associated 738 with an EVSE function to charge a connected EV using an optimal cost algorithm, and the digital signature may correspond to the outdoor environment where the user is located 742. In other words, the voice command 711 was given while the user was in an outdoor environment, and the acoustics of this outdoor environment had at least some effect (or at least a different effect than the indoor environment) on the digital waveform 722 and the subsequent digital signature 732 that are generated. The differences between the first and second examples can be visualized/understood in one way by, for example, comparing the digital waveform 721 and the digital waveform 722 and noting the differences/that these are distinct from each other in at least some ways. Note further that the respective digital signatures 731 and 732 are also different.

The training procedure previously described can further include incorporating/applying an indication of the applicable environment to the voice command being trained. For example, a device being used to train for the command (e.g., an EVSE, EVSE remote panel, or another device, such as a smartphone) may be present in a certain environment. The training device (or a server with which it communicates) may be aware of the environment that the device is in. This awareness may be, e.g., according to a preconfiguration at the device, perhaps as provided by an upstream operator of an EVSPS 700. In some of these cases, it is contemplated that a server of an EVSPS 700 may provide this environment information to an EVSE or EVSE remote panel. In other cases, the user may indicate the appropriate environment. For example, this may be done in the case of training a voice command with a smartphone. Then, as the user proceeds through the training of the voice command as previously described, the device or the server may associate the trained voice command with that environment. This training process may, in some embodiments, be repeated by the user for the same voice command 711 but in a different environment so that the multiple versions of the same voice command (but corresponding to the different environments) are so trained.

Further, it is contemplated that an entity of the EVSPS 700 (e.g., an EVSE, an EVSE remote panel, or a server) is capable of transforming a waveform recorded according to one known environment to a waveform corresponding to the same voice command but according to another environment. For example, an indoor EVSE or EVSE remote panel that is being used to train the voice command 711 may record the waveform 721. It (or a server of the EVSPS 700 with which the EVSE/EVSE remote panel communicates) may then generate the waveform 722 using the waveform 721. In this manner, each of the waveform 721 and the waveform 722 may both be generated, while only requiring the user to perform a single training “session.”

Once generated as described above, the one or more digital signatures (and their associations with the one or more environment types) may then be saved in a digital signature catalog (e.g., in a catalog of digital signatures for voice commands associated with the known user), for use consistent with description herein.

The differentiation of digital signatures for the same command 711 according to an environment within which the command 711 is spoken may enable a certain level or type of security within the system. For example, a device (e.g., an EVSE or and EVSE remote panel) receiving the command 711 may be aware of the environment that it operates in (e.g., according to a preconfiguration at the device, perhaps as provided by a server). Accordingly, once a user associated with the received command 711 has been identified and a match to particular digital signature has been made as described above, the EVSPS 700 may proceed to check that the matched-to digital signature is associated with an environment that matches the environment of the device.

For example, suppose that an EVSE is located in a garage of a residential house 3, as in FIG. 1, and that a legitimate user of the EVSE (e.g., a resident of the residential house 3) has trained the system (e.g., created the digital signature 731) to respond to the command 711 with initiating actions corresponding to an optimal charge mode. Further, the user trains the command 711 (e.g., trained the system to understand the command) using the EVSE, and either the user (manually) or an entity of the EVSPS 700 (automatically) associates the corresponding digital signature 731 with an indoor environment in the manner described above. Finally, the EVSE (or the server) is aware that the EVSE is located in an indoor environment (inside the garage 5).

Suppose then that a third party has (e.g., surreptitiously) recorded the user giving the command 711. The user leaves the home and secures the garage 5. The third party then attempts to cause the EVSE to act according to an EVSE function associated with the recorded command 711 by standing outside the garage and loudly playing back the recorded command 711. In the case where the EVSPS 700 uses differentiation according to environment as described herein, this will not work. At best, the playback of the recording may result in the generation of the digital signature 732 (and not the digital signature 731), due to the acoustical effects of the outdoor location of the third party (if these acoustical effects in combination with the recording even manage to generate a waveform that results in a match to a cataloged digital signature in the first instance). Then, because the EVSE/the server understands that the EVSE capturing this playback is located in an indoor location, the EVSE will not perform/be instructed by the server to perform the operation. Accordingly device operations (e.g., of an EVSE) in a private location (e.g., a home) can be secured from this form of “playback” intrusion from outsiders.

Note that, in some cases, an EVSE/EVSE remote panel may be configured to use voice control for operations other than those strictly related to EV charging. For example, an EVSE/EVSE remote panel may be configured to use voice control to perform an operation that opens the garage door. In this case, the security against the “playback” types of intrusions that is provided by environment-based differentiation as described may prevent the outside entity from “spoofing” a successful command to open the door of the garage 5, thereby keeping the premises secure.

One or more environments to which an EVSE/EVSE remote panel corresponds may be set by a user, or may be set by an operator of the EVSPS 700 (e.g., via the server). Further, it may be that some EVSE/EVSE remote panels are instead programmed to simply process digital signatures according to their corresponding command without considering environmental association aspects.

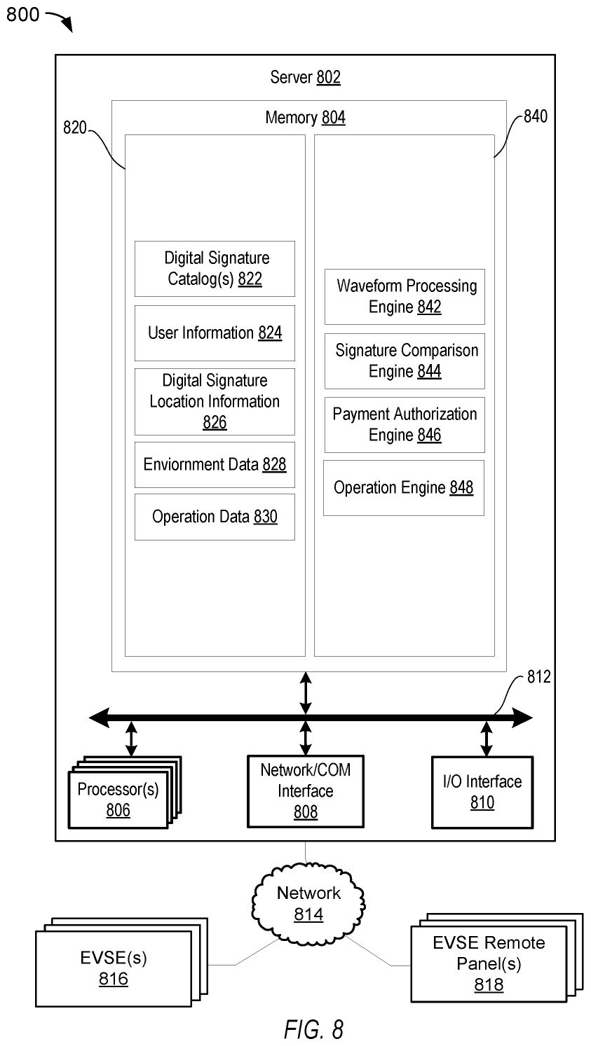

FIG. 8 illustrates an EVSPS 800 in accordance with an embodiment of the disclosure. The EVSPS 800 includes a server 802, one or more EVSE(s) 816, and one or more EVSE remote panel(s) 818. FIG. 8 includes a detailed view of a server 802.

The server 802 may include a memory 804, one or more processor(s) 806, a network/COM interface 808, and an input/output (I/O) interface 810, which may all communicate with each other using a system bus 812.

The memory 804 of the server 802 may correspond to, for example, the server storage system 154 of FIG. 2. The memory 804 of the server 802 may include a data store 820. The data store 820 may include the digital signature catalogs 822, the user information 824, the digital signature location information 826, the environment data 828, and the operation data 830.

The digital signature catalog(s) 822 may include one or more catalogs of digital signatures corresponding to voice commands that have been trained at the EVSPS 800 in the manner described above. The digital signature catalog(s) 822 may further include one or more catalogs of alert digital signatures for various users. The digital signature catalog(s) 822 may be generated at the server 802 according to the training processes described above.

The user information 824 may include information regarding authorized users of the EVSPS 800. Authorized users may include users for which there are one or more digital signatures in the digital signature catalog(s) 822. Further, the user information 824 may include information regarding an association between one or more users and one or more of the digital signature catalogs 822 (e.g., in a case where a catalog is for digital signatures associated with that user). The user information 824 may further include account information for one or more users for use in providing or processing a payment associated with the use of an EVSE 816 (e.g., to a third party such as a power supplier for the EVSE 816) according to one or more EVSE functions associated with the digital signatures in the digital signature catalog(s) 822. The user information 824 may further include information regarding associations between users and vehicles which such users are authorized to charge or otherwise interact with via the EVSPS 800.

The digital signature location information 826 may include location information for one or more of the digital signatures in the digital signature catalog(s) 822. Location information for a digital signature may correspond to a location of a device of the EVSPS 800 (e.g., an EVSE 816 or an EVSE remote panel 818) where that digital signature was generated via the training process previously described. Alternatively, the location information corresponding to a digital signature may be set by, e.g., a server or a user of the EVSPS 800. This location information may be used to determine a set of one or more digital signatures to use for digital signature comparison according to a known geophysical region, in the manner described above. The digital signature location information 826 may be used to arrange catalogs (or sub-catalogs) within the digital signature catalog(s) 822 according to a known geophysical region.

The environment data 828 may include data for an environment corresponding to one or more of the EVSE(s) 816 and/or the EVSE remote panel(s) 818. This information may be indicated by a user of the EVSE(s) 816 or the EVSE remote panel(s) 818, or be set by an operator of the server 802.

The operation data 830 may include data that is used for operating the features of the server 802 that are not more specifically described herein. For example, the operation data 830 may include an operating system for the server 802, data detailing the associations between elements of the data store 820 and the engines 840, etc.

The data store 820 may include data generated by the server 802, such as by the engines 840 or other modules. The data of the data store 820 may be organized as one or more data structures.

In addition to the data store 820, the memory 804 of the server 802 may further include engines 840. The engines 840 may include a waveform processing engine 842, a signature comparison engine 844, a payment authorization engine 846, and an operation engine 848.

The waveform processing engine 842 may receive (e.g., via the network 814) a waveform as recorded by, e.g., an EVSE 816 or an EVSE remote panel 818 and convert it into a digital signature.

The signature comparison engine 844 may compare a digital signature (e.g., as generated from a received waveform) to one or more digital signatures from the digital signature catalog(s) 822, in order to locate a match, as discussed above. This process may include performing successive searches through various ones of the digital signature catalog(s) according to their relevant distance tiers as determined according to the geophysical region(s) associated with such catalogs, until a match is found (as previously described). This process may include ensuring that an environment corresponding to a generated digital signature matches an environment for the device (e.g., EVSE or EVSE remote panel) that sourced the audio used to generate the digital signature. This matching process may cause a user to be authenticated, in the manner described above.

The payment authorization engine 846 may authorize payments that underpin/enable the one or more EVSE functions associated with the voice command provided by the user. For example, a user may provide the server 802 (e.g., via interaction with an EVSE 816, an EVSE remote panel 818, or another device connected to the network 814, such as a personal computer or smartphone) account data for an account that is to be used to pay for the charging provided by an EVSE 816. As described above, this account data may be associated by the user for use with one or more (including all) of the trained voice commands for one or more users (and this information may be stored in the user information 824). Then, upon the server 802 identifying a digital signature corresponding to a voice command given by a user (e.g., at an EVSE 816 or an EVSE remote panel 818), the payment authorization engine 846 may check this account data information against the digital signature corresponding to the EVSE function that is to be performed to ensure that for the user giving the command, that account may be used for that EVSE function, as discussed above. Further, the payment authorization engine 846 may perform the transmission of a payment instruction for paying for the EVSE function (e.g., for paying a power supplier for the EVSE 816 performing the EVSE function). In some embodiments, where a voice command is not associated with a payment method, or where a payment method associated with a voice command is not valid at the EVSE 816 or the EVSE remote panel 818 being used, payment information may be received by the payment authorization engine 846 over the network 814 which may be used to generate such a payment instruction.

The operation engine 848 may operate the features of the server 802 that are not more specifically described herein. For example, the operation engine 848 may operate an operating system for the server 802, transport data on the system bus 812, add/remove data from the data store 820, perform/enable the described communications with one or more of the EVSE(s) 816 and the EVSE remote panel(s) 818 via the network 814, etc.

The engines 840 may run multiple operations concurrently or in parallel by or on the one or more processor(s) 806. In some embodiments, portions of the disclosed modules, components, and/or facilities are embodied as executable instructions stored in hardware or in firmware, or stored on a non-transitory, machine-readable storage medium. The instructions may comprise computer code that, when executed by the one or more processor(s) 806, cause the server 802 to implement certain processing steps, procedures, and/or operations, as disclosed herein.

The functions of the server 802 have been discussed in terms of engines 840 in the memory 804, which is a description that is given by example and not by way of limitation.

Persons having ordinary skill in the art will recognize that any of the engines 840 may operate using any elements (either alone or in combination) of the server 802, including (but not limited to) the memory 804, the processor(s) 806, the network/com interface 808, the I/O interface 810, and the system bus 812. Further, persons having ordinary skill in the art will recognize that the engines 840 may operate using other elements not shown herein (e.g., a custom computer chip with firmware to operate all or part of one or more of the engines 840). Further, it is contemplated that the engines 840 may include additional functionality other than what has been described.

The memory 804 of the server 802 may store data in a static manner. For example, the memory 804 may comprise, e.g., a hard disk capable of storing data even during times when the server 802 is not powered on. The memory 804 may also store data in a dynamic manner. For example, the memory 804 may comprise Random Access Memory (RAM) storage configured to hold engines (including engines 840). The memory 804 may include static RAM, dynamic RAM, flash memory, one or more flip-flops, ROM, CD-ROM, DVD, disk, tape, or magnetic, optical, or other computer storage medium, including at least one non-volatile storage medium. The memory 804 is capable of storing machine-readable and -executable instructions that the one or more processor(s) 806 are capable of reading and executing. The memory 804 may be local to the server 802 and may comprise a memory module or subsystem remote from server 802 and/or distributed over a network (including the network 814).

The one or more processor(s) 806 of the server 802 may perform the functionalities already described herein. In addition, the processors 806 may perform other system control tasks, such as controlling data flows on the system bus 812 between the memory 804, the network/COM interface 808, and the I/O interface 810. The details of these (and other) background operations may be defined in operating system instructions (not shown) upon which the one or more processor(s) 806 operate.

The one or more processor(s) 806 may include one or more general purpose devices, such as an Intel®, AMD®, or other standard microprocessor; and/or a special purpose processing device, such as ASIC, SoC, SiP, FPGA, PAL, PLA, FPLA, PLD, or other customized or programmable device. The one or more processor(s) 806 may perform distributed (e.g., parallel) processing to execute or otherwise implement functionalities of the present embodiments. The one or more processor(s) 806 may run a standard operating system and perform standard operating system functions.

The network/COM interface 808 of the server 802 may be connected to a network 814 and may act as a reception and/or distribution device for computer-readable instructions. This connection may facilitate the transfer of information (e.g., computer-readable instructions) from the server 802 to and from the one or more EVSE(s) 816 and to and from the one or more EVSE remote panel(s) 818. The network 814 may include, for example, the network router/gateway 112 previously discussed. The network/COM interface 808 may facilitate communication with other computing devices and/or networks, such as the Internet and/or other computing and/or communications networks. The network/COM interface 808 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 810 may comprise any mechanism allowing an operator to interact with and/or provide data to the server 802. For example, the I/O interface 810 may include a keyboard, a mouse, a monitor, and/or a data transfer mechanism, such as a disk drive or a flash memory drive. The I/O interface 810 may allow an operator to place information in the memory 804, or to issue instructions to the server 802 to perform any of the functions described herein.

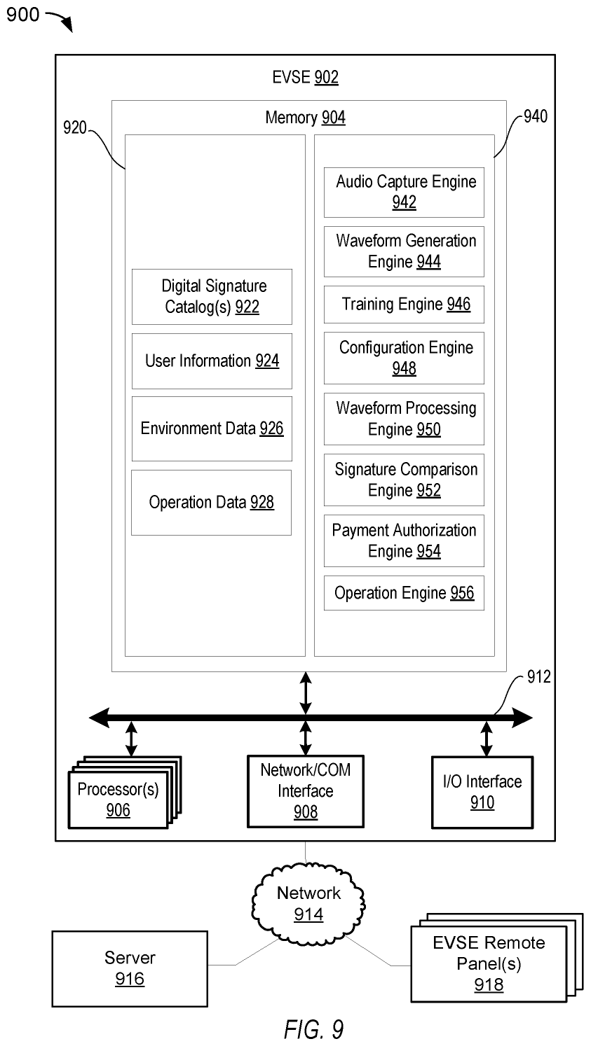

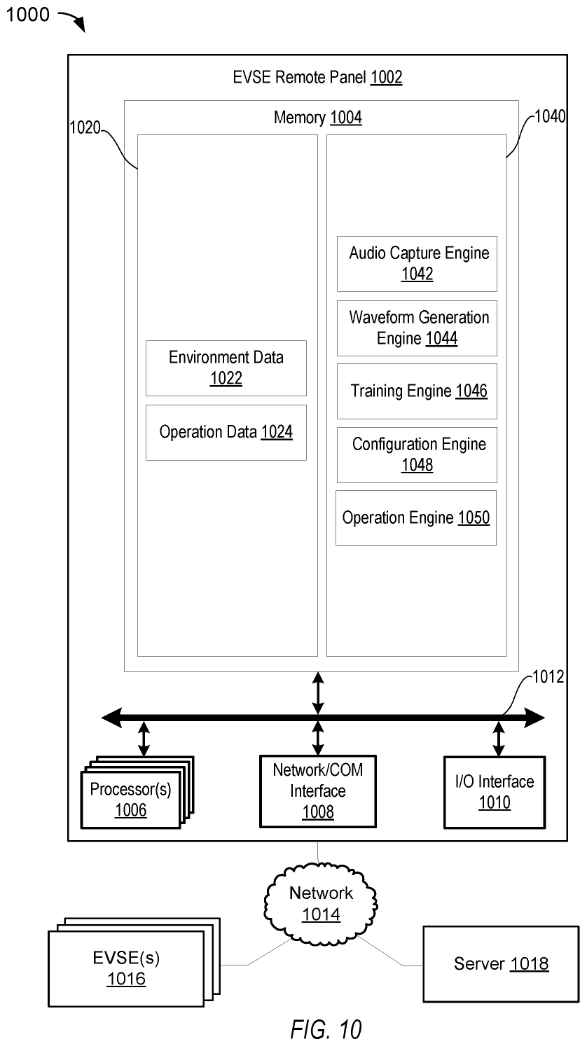

FIG. 9 illustrates an EVSPS 900 in accordance with an embodiment of the disclosure. The EVSPS 900 includes an EVSE 902, a server 916, and one or more EVSE remote panel(s) 918. FIG. 9 includes a detailed view of the EVSE 902.

Note that in embodiments of an EVSPS that do not include the server 916, it may be that an EVSE according to the EVSE 902 (but not ultimately in communication with the server 916) performs one or more functions that might otherwise be performed by the server 916. Accordingly, in the EVSE 902 of FIG. 9, these functions (and associated data store information) are described below as being present in at least some embodiments of an EVSE 902.

The EVSE 902 may include a memory 904, one or more processor(s) 906, a network/COM interface 908, and an input/output (I/O) interface 910, which may all communicate with each other using a system bus 912.

The memory 904 of the EVSE 902 may correspond to, for example, the storage system 134 of FIG. 2. The one or more processor(s) 906 may correspond to, for example, the microprocessor 132 of FIG. 2.

The memory 904 of the EVSE 902 may include a data store 920. The data store 920 may include the digital signature catalog(s) 922, user information 924, the environment data 926, and the operation data 928.

The digital signature catalog(s) 922 may be included in at least some embodiments of the EVSE 902. The digital signature catalog(s) 922 comprise some or all of the information described in relation to the digital signature catalog(s) 822 of the server 802 of FIG. 8. The inclusion of the same information as in the digital signature catalog(s) 822 may be particularly useful in cases (not shown in FIG. 9) where the EVSPS 900 does not include a server 916, according to some embodiments of the present disclosure. Note also that even in cases where the server 916 is included in the EVSPS 900, but where it is the EVSE 902 (and not the server 916) that is responsible for identifying a user (as discussed in some embodiments above), the digital signature catalog(s) 922 local to the EVSE 902 may still include one or more catalogs of alert digital signatures for various users of the EVSPS 900.

The user information 924 may be included in at least some embodiments of the EVSE 902. The user information 924 may comprise some or all of the information described in relation to the user information 824 of the server 802 of FIG. 8. The inclusion of the same information as in the user information 824 may be particularly useful in cases (not shown in FIG. 9) where the EVSPS 900 does not include a server 916, according to some embodiments of the present disclosure. Note also that even in cases where the server 916 is included in the EVSPS 900, but where it is the EVSE 902 (and not the server 916) that is responsible for identifying a user (as discussed in some embodiments above), the user information 924 local to the EVSE 902 may still include information associating one or more users to one or more digital signatures of the digital signature catalog(s) 922.

The environment data 926 may include data for an environment corresponding to the EVSE 902. This information may be indicated by a user of the EVSE 902, or can be set by an operator of the server 916. The environment data 926 may also include environments corresponding to the EVSE remote panel(s) in cases (not shown in FIG. 9) where the EVSPS 900 does not include a server 916, according to some embodiments of the present disclosure.

The operation data 928 may include data that is used for operating the features of the EVSE 902 that are not more specifically described herein. For example, the operation data 928 may include an operating system for the EVSE 902, data detailing the associations between elements of the data store 920 and the engines 940, etc.

The data store 920 may include data generated by the EVSE 902, such as by the engines 940 or other modules. The data of the data store 920 may be organized as one or more data structures.

In addition to the data store 920, the memory 904 of the EVSE 902 may further include engines 940. The engines 940 may include an audio capture engine 942, a waveform generation engine 944, a training engine 946, a configuration engine 948, a waveform processing engine 950, a signature comparison engine 952, a payment authorization engine 954, and an operation engine 956.

The audio capture engine 942 may capture audio from a user using one or more microphones of the EVSE 902, as described above. The audio capture engine may also perform other associated tasks, such as, for example, filtering out captured user audio from any background noise.

The waveform generation engine 944 may receive captured user audio and generate one or more waveforms for such audio. For example, the waveform generation engine 944 may generate a digital waveform corresponding to a voice command of a user using the captured user audio. The waveform generation engine may also, for example, generate waveforms corresponding to alert signals found in the captured user audio. The data generated by the waveform generation engine 944 may be sent to the server 916.

The training engine 946 may perform the training functions for one or more voice commands, in the manner described herein. The training engine 946 may use the I/O interface 910 (e.g., speakers, displays, microphones) in order to complete this training. Where appropriate, the results of the training (e.g., digital signatures, along with any indications of an associated user, an associated form of payment, an associated EV, an associated environment, etc.) may be sent for storage and use at the server 916.

The configuration engine 948 may be used by the EVSE 902 to perform configuration functions at the EVSE 902. For example, the configuration engine 948 may be used to implement (via the I/O interface 910) an instruction from the user to associate the EVSE 902 with a certain location, an instruction to allow/disallow a payment method to be used with one or more voice commands of a given user, an instruction to add an association between a vehicle and a user, etc. The data generated by the configuration engine may be sent to the server 916.

The waveform processing engine 950 may be included in at least some embodiments of the EVSE 902. The waveform processing engine 950 may perform aspects described in relation to the waveform processing engine 842 of the server 802 of FIG. 8. The inclusion of the waveform processing engine 950 may be particularly useful in cases (not shown in FIG. 9) where the EVSPS 900 does not include a server 916, according to some embodiments of the present disclosure. Note also that even in cases where the server 916 is included in the EVSPS 900, but where it is the EVSE 902 (and not the server 916) that is responsible for identifying a user (as discussed in some embodiments above), the waveform processing engine 950 of the EVSE 902 may still be present (for example, in order to generate a signature corresponding to a captured alert signal to enable signature comparisons using the signature to identify the user).

The signature comparison engine 952 may be included in at least some embodiments of the EVSE 902. The signature comparison engine 952 may perform aspects described in relation to the signature comparison engine 844 of the server 802 of FIG. 8. The inclusion of the signature comparison engine 952 may be particularly useful in cases (not shown in FIG. 9) where the EVSPS 900 does not include a server 916, as is according to some embodiments of the present disclosure. Note also that even in cases where the server 916 is included in the EVSPS 900, but where it is the EVSE 902 (and not the server 916) that is responsible for identifying a user (as discussed in some embodiments above), the signature comparison engine 952 of the EVSE 902 may still be present (for example, in order to match signatures corresponding to captured alert signals to corresponding signatures for those alert signals from the digital signature catalog(s) 922 to authenticate users).

The payment authorization engine 954 may be included in at least some embodiments of the EVSE 902. The payment authorization engine 954 may perform aspects described in relation to the payment authorization engine 846 of the server 802 of FIG. 8 The inclusion of the payment authorization engine 954 may be particularly useful in cases (not shown in FIG. 9) where the EVSPS 900 does not include a server 916, according to some embodiments of the present disclosure. It is contemplated that the payment authorization engine 954 may, similarly to the payment authorization engine 846 of the server 802, make use of payment information separate from a voice command as sourced at, e.g., a payment acceptance component of the I/O interface 910 of the EVSE 902, or as received from an EVSE remote panel 918 to generate a payment instruction.

The operation engine 956 may operate the features of the EVSE 902 that are not more specifically described herein. For example, the operation engine 956 may operate an operating system for the EVSE 902, transport data on the system bus 912, add/remove data from the data store 920, perform/enable the described communications with one or more of the server 916 and the EVSE remote panel(s) 918 via the network 914, etc.

The engines 940 may run multiple operations concurrently or in parallel by or on the one or more processor(s) 906. In some embodiments, portions of the disclosed modules, components, and/or facilities are embodied as executable instructions stored in hardware or in firmware, or stored on a non-transitory, machine-readable storage medium. The instructions may comprise computer code that, when executed by the one or more processor(s) 906, cause the server 902 to implement certain processing steps, procedures, and/or operations, as disclosed herein.

That functions of the EVSE 902 have been discussed in terms of engines 940 in the memory 904 is given by example and not by way of limitation. Persons having ordinary skill in the art will recognize that any of the engines 940 may operate using any elements (either alone or in combination) of the EVSE 902, including (but not limited to) the memory 904, the processor(s) 906, the network/com interface 908, the I/O interface 910, and the system bus 912. Further, persons having ordinary skill in the art will recognize that the engines 940 may operate using other elements not shown herein (e.g., a custom computer chip with firmware to operate all or part of one or more of the engines 940). Further, it is contemplated that the engines 940 may include additional functionality other than what has been described.

The memory 904 of the EVSE 902 may store data in a static manner. For example, the memory 904 may comprise, e.g., a hard disk capable of storing data even during times when the EVSE 902 is not powered on. The memory 904 may also store data in a dynamic manner. For example, the memory 904 may comprise Random Access Memory (RAM) storage configured to hold engines (including engines 940). The memory 904 may include static RAM, dynamic RAM, flash memory, one or more flip-flops, ROM, CD-ROM, DVD, disk, tape, or magnetic, optical, or other computer storage medium, including at least one non-volatile storage medium. The memory 904 is capable of storing machine-readable and -executable instructions that the one or more processor(s) 906 are capable of reading and executing. The memory 904 may be local to the EVSE 902 and may comprise a memory module or subsystem remote from EVSE 902 and/or distributed over a network (including the network 914).

The one or more processor(s) 906 of the EVSE 902 may perform the functionalities already described herein. In addition, the processors 906 may perform other system control tasks, such as controlling data flows on the system bus 912 between the memory 904, the network/COM interface 908, and the I/O interface 910. The details of these (and other) background operations may be defined in operating system instructions (not shown) upon which the one or more processor(s) 906 operate.

The one or more processor(s) 906 may include one or more general purpose devices, such as an Intel®, AMD®, or other standard microprocessor; and/or a special purpose processing device, such as ASIC, SoC, SiP, FPGA, PAL, PLA, FPLA, PLD, or other customized or programmable device. The one or more processor(s) 906 may perform distributed (e.g., parallel) processing to execute or otherwise implement functionalities of the present embodiments. The one or more processor(s) 906 may run a standard operating system and perform standard operating system functions.

The network/COM interface 908 of the EVSE 902 may be connected to a network 914 and may act as a reception and/or distribution device for computer-readable instructions. This connection may facilitate the transfer of information (e.g., computer-readable instructions) from the EVSE 902 to and from the server 916 and to and from the one or more EVSE remote panel(s) 918. The network 914 may include, for example, the network router/gateway 112 previously discussed. The network/COM interface 908 may facilitate communication with other computing devices and/or networks, such as the Internet and/or other computing and/or communications networks. The network/COM interface 908 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 910 may comprise any mechanism allowing an operator to interact with and/or provide data to the EVSE 902. Accordingly, the I/O interface 910 may include one or more microphones, one or more displays, one or more buttons, one or more speakers, and/or a payment acceptance component for the EVSE 902. A payment acceptance component on the EVSE 902 may be used in the event that a user needs to provide payment information to the EVSPS 900 attendant to the use of the EVSE 902 to cause the EVSE 902 to charge an EV (e.g., in the event that a voice command is not associated with a payment method, or the payment method associated with the voice command cannot be used with the particular EVSE remote panel, as described above). In embodiments according to the EVSPS 900 that use the server 916, the EVSE 902 may provide this information to, e.g., the server 916 that has a payment authorization engine for use in generating and sending a payment instruction; alternatively, this information may be used by a payment authorization engine of the EVSE 902 to generate and send a payment instruction in embodiments of an EVSPS that does not include the server 916. Further, the I/O interface 910 may include a keyboard, a mouse, a monitor, and/or a data transfer mechanism, such as a disk drive or a flash memory drive. The I/O interface 910 may allow an operator to place information in the memory 904, or to issue instructions to the EVSE 902 to perform any of the functions described herein.

FIG. 10 illustrates an EVSPS 1000 in accordance with an embodiment of the disclosure. The system 1000 includes an EVSE remote panel 1002, one or more EVSE(s) 1016, and a server 1018. FIG. 10 includes a detailed view of an EVSE remote panel 1002.

The EVSE remote panel 1002 may include a memory 1004, one or more processor(s) 1006, a network/COM interface 1008, and an input/output (I/O) interface 1010, which may all communicate with each other using a system bus 1012.

The memory 1004 of the EVSE remote panel 1002 may correspond to, for example, the storage system 144 of FIG. 3. The one or more processor(s) 1006 may correspond to, for example, the microprocessor 142 of FIG. 3.

The memory 1004 of the EVSE remote panel 1002 may include a data store 1020. The data store 1020 may include the environment data 1022 and the operation data 1024.

The environment data 1022 may include data for an environment corresponding to the EVSE remote panel 1002. This information may be indicated by a user of the EVSE remote panel 1002, or be set by an operator of the server 1018.

The operation data 1024 may include data that is used for operating the features of the EVSE remote panel 1002 that are not more specifically described herein. For example, the operation data 1024 may include an operating system for the EVSE remote panel 1002, data detailing the associations between elements of the data store 1020 and the engines 1040, etc.

The data store 1020 may include data generated by the EVSE remote panel 1002, such as by the engines 1040 or other modules. The data of the data store 1020 may be organized as one or more data structures.

In addition to the data store 1020, the memory 1004 of the EVSE remote panel 1002 may further include engines 1040. The engines 1040 may include an audio capture engine 1042, a waveform generation engine 1044, a training engine 1046, a configuration engine 1048, and an operation engine 1050.

The audio capture engine 1042 may capture audio from a user using one or more microphones of the EVSE remote panel 1002, as described above. The audio capture engine may also perform other associated tasks, such as, for example, filtering out this, e.g., human vocal audio from any background noise.

The waveform generation engine 1044 may receive captured audio from the user and generate one or more waveforms for such audio. For example, the waveform generation engine 1044 may generate a digital waveform corresponding to a voice command of a user using the captured audio. The waveform generation engine may also, for example, generate waveforms corresponding to alert signals found in the captured audio. The data generated by the waveform generation engine 1044 may be sent to one or more of the server 1018 and/or the EVSE 1016. Sending this data to the EVSE 1016 may be particularly useful in embodiments of an EVSPS (not illustrated by EVSPS 1000) where there is no server 1018.

The training engine 1046 may perform the training functions for one or more voice commands, in the manner described herein. The training engine 1046 may use the I/O interface 1010 (e.g., speakers, displays, microphones) in order to complete this training. Where appropriate, the results of the training (e.g., digital signatures, along with any indications of an associated user, an associated form of payment, an associated EV, an associated environment, etc.) may be sent for storage and use at one of the server 1018 and EVSE 1016. Sending this data to the EVSE 1016 may be particularly useful in embodiments of an EVSPS (not illustrated by EVSPS 1000) where there is no server 1018.

The configuration engine 1048 may be used by the EVSE remote panel 1002 to perform configuration functions at the EVSE remote panel 1002. For example, the configuration engine 1048 may be used to implement (via the I/O interface 1010) an instruction from the user to associate the EVSE remote panel 1002 with a certain location, an instruction to allow/disallow a payment method to be used with one or more voice commands of a given user, an instruction to add an association between a vehicle and a user, etc. The data generated by the configuration engine may be sent to one or more of the server 1018 and an EVSE 1016. Sending this data to the EVSE 1016 may be particularly useful in embodiments of an EVSPS (not illustrated by EVSPS 1000) where there is no server 1018.

The operation engine 1050 may operate the features of the EVSE remote panel 1002 that are not more specifically described herein. For example, the operation engine 1050 may operate an operating system for the EVSE remote panel 1002, transport data on the system bus 1012, add/remove data from the data store 1020, perform/enable the described communications with one or more of the EVSE(s) 1016 and the server 1018 via the network 1014, etc.

The engines 1040 may run multiple operations concurrently or in parallel by or on the one or more processor(s) 1006. In some embodiments, portions of the disclosed modules, components, and/or facilities are embodied as executable instructions stored in hardware or in firmware, or stored on non-transitory, machine-readable storage medium. The instructions may comprise computer code that, when executed by the one or more processor(s) 1006, cause the EVSE remote panel 1002 to implement certain processing steps, procedures, and/or operations, as disclosed herein.

That functions of the EVSE remote panel 1002 have been discussed in terms of engines 1040 in the memory 1004 is given by example and not by way of limitation. Persons having ordinary skill in the art will recognize that any of the engines 1040 may operate using any elements (either alone or in combination) of the EVSE remote panel 1002, including (but not limited to) the memory 1004, the processor(s) 1006, the network/COM interface 1008, the I/O interface 1010, and the system bus 1012. Further, persons having ordinary skill in the art will recognize that the engines 1040 may operate using other elements not shown herein (e.g., a custom computer chip with firmware to operate all or part of one or more of the engines 1040). Further, it is contemplated that the engines 1040 may include additional functionality other than what has been described.

The memory 1004 of the EVSE remote panel 1002 may store data in a static manner. For example, the memory 1004 may comprise, e.g., a hard disk capable of storing data even during times when the EVSE remote panel 1002 is not powered on. The memory 1004 may also store data in a dynamic manner. For example, the memory 1004 may comprise Random Access Memory (RAM) storage configured to hold engines (including engines 1040). The memory 1004 may include static RAM, dynamic RAM, flash memory, one or more flip-flops, ROM, CD-ROM, DVD, disk, tape, or magnetic, optical, or other computer storage medium, including at least one non-volatile storage medium. The memory 1004 is capable of storing machine-readable and -executable instructions that the one or more processor(s) 1006 are capable of reading and executing. The memory 1004 may be local to the EVSE remote panel 1002 and may comprise a memory module or subsystem remote from server 1002 and/or distributed over a network (including the network 1014).

The one or more processor(s) 1006 of the EVSE remote panel 1002 may perform the functionalities already described herein. In addition, the processors 1006 may perform other system control tasks, such as controlling data flows on the system bus 1012 between the memory 1004, the network/COM interface 1008, and the I/O interface 1010. The details of these (and other) background operations may be defined in operating system instructions (not shown) upon which the one or more processor(s) 1006 operate.

The one or more processor(s) 1006 may include one or more general purpose devices, such as an Intel®, AMD®, or other standard microprocessor; and/or special purpose processing device, such as ASIC, SoC, SiP, FPGA, PAL, PLA, FPLA, PLD, or other customized or programmable device. The one or more processor(s) 1006 may perform distributed (e.g., parallel) processing to execute or otherwise implement functionalities of the present embodiments. The one or more processor(s) 1006 may run a standard operating system and perform standard operating system functions.

The network/COM interface 1008 of the EVSE remote panel 1002 may be connected to a network 1014 and may act as a reception and/or distribution device for computer-readable instructions. This connection may facilitate the transfer of information (e.g., computer-readable instructions) from the EVSE remote panel 1002 to and from the one or more EVSE(s) 1016 and to and from the server 1018. The network 1014 may include, for example, the network router/gateway 112 previously discussed. The network/COM interface 1008 may facilitate communication with other computing devices and/or networks, such as the Internet and/or other computing and/or communications networks. The network/COM interface 1008 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 1010 may comprise any mechanism allowing an operator to interact with and/or provide data to the EVSE remote panel 1002. These may include one or more microphones, one or more displays, one or more buttons, one or more speakers, and/or a payment acceptance component. A payment acceptance component on an EVSE remote panel may be used in the event that a user needs to provide payment information to the EVSPS 1000 attendant to the use of the EVSE remote panel 1002 to cause an EVSE to charge an EV (e.g., in the event that a voice command is not associated with a payment method, or the payment method associated with the voice command cannot be used with the particular EVSE remote panel, as described above). The EVSE remote panel may provide this information to the relevant device with a payment processing engine (e.g., the relevant EVSE 1016 and/or the server 1018) such that a payment instruction can be generated and sent. Further, the I/O interface 1010 may include a keyboard, a mouse, a monitor, and/or a data transfer mechanism, such as a disk drive or a flash memory drive. The I/O interface 1010 may allow an operator to place information in the memory 1004, or to issue instructions to the EVSE remote panel 1002 to perform any of the functions described herein.

### EXAMPLES

The following are some examples according to systems and methods disclosed herein. In order to avoid complexity in providing the disclosure, not all of the examples listed below are separately and explicitly disclosed as having been contemplated herein as combinable with all of the other examples listed below and other embodiments disclosed hereinabove. Unless one of ordinary skill in the art would understand that these examples listed below (and the above disclosed embodiments) are not combinable, it is contemplated within the scope of the disclosure that such examples and embodiments are combinable.

Example 1. A server of an electric vehicle service provisioning system (EVSPS), comprising: one or more processors, and a memory comprising: a cataloged digital signature; and instructions that when executed by the one or more processors, configure the server to: receive, from a microphone-enabled device of the EVSPS, a waveform corresponding to a voice command; process the waveform into a digital signature; determine a mode for charging an electric vehicle (EV) based on a comparison of the digital signature to the cataloged digital signature; and send an instruction to an electric vehicle supply equipment (EVSE) to charge the EV according to the mode.

Example 2. The server of Example 1, wherein the memory further comprises instructions that, when executed by the one or more processors, configure the server to: identify a user that provided the voice command; and determine that the user is authorized to charge the EV according to the mode.

Example 3. The server of Example 1, wherein the memory further comprises instructions that, when executed by the one or more processors, configure the server to determine whether an environment corresponding to the digital signature matches an environment of the microphone-enabled device.

Example 4. The server of Example 1, wherein the microphone-enabled device is the EVSE.

Example 5. The server of Example 1, wherein the microphone-enabled device is an EVSE remote panel.

Example 6. The server of Example 1, wherein the voice command identifies the EV.

Example 7. The server of Example 1, wherein the mode for charging comprises one of an optimal cost mode, a rapid charge mode, a battery maintenance mode, and a wait mode.

Example 8. The server of Example 1, wherein: the cataloged digital signature is associated with a payment method to use to pay for the charging of the EV according to the mode; and the instructions, when executed by the one or more processors, further configure the server to authorize the use of the payment method to pay for the charging of the EV according to the mode.

Example 9. A device of an electric vehicle service provisioning system (EVSPS), comprising: one or more microphones; one or more processors; and a memory comprising instructions that, when executed by the one or more processors, configure the device to: receive audio comprising a voice command from a user on the one or more microphones; generate a waveform based on the voice command; and send the waveform to a server of the EVSPS.

Example 10. The device of Example 9, wherein the device comprises an electric vehicle supply equipment (EVSE) of the EVSPS that further comprises: an electrical connection to an electric power source; and a service coupling configured to couple to an electric vehicle (EV) and provide power from the electric power source to the EV; and wherein the memory further comprises instructions that, when executed by the one or more processors, configure the EVSE to: receive an instruction from the server to charge the EV according to a mode; and charge the EV according to the mode via the service coupling.

Example 11. The device of Example 10, wherein the memory further comprises instructions that, when executed by the one or more processors, configure the EVSE to determine that the service coupling is coupled to the EV.

Example 12. The device of Example 9, wherein the device comprises an electric vehicle supply equipment (EVSE) remote panel.

Example 13. The device of Example 12, wherein the EVSE remote panel is configured to communicate with an EVSE of the EVSPS.

Example 14. The device of Example 9, wherein the memory further comprises instructions that, when executed by the one or more processors, configure the device to isolate the voice command from the audio.

Example 15. A method of a voice-activated electric service provisioning system (EVSPS), comprising: receiving audio comprising a voice command of a user; recording the voice command as a waveform; processing the waveform into a digital signature; determining a mode for charging an electric vehicle (EV) by comparing the digital signature to a cataloged digital signature; and charging the EV according to the mode.

Example 16. The method of Example 15, further comprising: identifying the user based on the audio; and determining that the user is authorized to charge the EV according to the mode.

Example 17. The method of Example 15, further comprising determining whether an environment corresponding to the digital signature matches an environment of a device of the EVSPS that receives the audio.

Example 18. The method of Example 15, wherein the audio is received on two or more microphones, and further comprising isolating the voice command from the audio.

Example 19. The method of Example 15, wherein the voice command identifies the EV.

Example 20. The method of Example 15, wherein: the cataloged digital signature is associated with a payment method to use to pay for the charging of the EV according to the mode; and further comprising authorizing the use of the payment method to pay for the charging of the EV according to the mode.

Example 21. The method of Example 15, wherein the mode for charging comprises one of an optimal cost mode, a rapid charge mode, a battery maintenance mode, and a wait mode.

Example 22. The method of Example 15, wherein the voice command is received at a remote panel of the EVSPS that is separate from an electric vehicle supply equipment (EVSE) of the EVSPS that performs the charging of the EV.

Example 23. The method of Example 15, further comprising determining that a service coupling of the EVSPS is coupled to the EV.

Example 24. A device of an electric vehicle service provisioning system (EVSPS), comprising: one or more microphones; one or more processors; and a memory comprising instructions that, when executed by the one or more processors, configure the device to: receive, from a user, an indication of a command for electric vehicle (EV) charging according to a mode; receive, from the user, one or more audio inputs corresponding to the command for EV charging according to the mode; generate one or more digital signals based on the one or more audio inputs; generate a base set of discrete signals using the one or more digital signals; generate a digital signature using the base set of discrete signals; and associate the digital signature with the command for EV charging according to the mode.

Example 25. The device of Example 24, wherein the memory further comprises instructions that, when executed by the one or more processors, configure the device to: receive, from the user, an identification of an EV; and associate the digital signature with the EV.

Example 26. The device of Example 24, wherein the memory further comprises instructions that, when executed by the one or more processors, configure the device to associate the digital signature with an environment of the device.

Example 27. The device of Example 24, wherein the memory further comprises instructions that, when executed by the one or more processors, configure the device to: identify the user; and associate the digital signature with the user.

Example 28. The device of Example 24, wherein the memory further comprises instructions that, when executed by the one or more processors, configure the device to: receive, from the user, an indication of a payment method; and associate the digital signature with the payment method.

Example 29. The device of Example 24, wherein the memory further comprises instructions that, when executed by the one or more processors, configure the device to generate the base set of discrete signals by removing excursions from an initial set of discrete signals.

Example 30. The device of Example 24, wherein the memory further comprises instructions that, when executed by the one or more processors, configure the device to filter out local ambient noise from the one or more digital signals.

Example 31. The device of Example 24, wherein the device comprises an electric vehicle supply equipment (EVSE), and wherein the memory further comprises instructions that, when executed by the one or more processors, configure the EVSE to send the association between the digital signature with the command for EV charging according to the mode to a server.

Example 32. The device of Example 24, wherein the device is an electric vehicle supply equipment (EVSE) remote panel, and wherein the memory further comprises instructions that, when executed by the one or more processors, configure the EVSE remote panel to send the association between the digital signature with the command for EV charging according to the mode to a server and to an EVSE.

Example 33. A method of a voice-activated electric vehicle service provisioning system (EVSPS), comprising: receiving, from a user, an indication of a command for electric vehicle (EV) charging according to a mode; receiving, from the user, one or more audio inputs corresponding to the command for EV charging according to the mode; generating one or more digital signals based on the one or more audio inputs; generating a base set of discrete signals using the one or more digital signals; generating a digital signature using the base set of discrete signals; and associating the digital signature with the command for EV charging according to the mode.

Example 34. The method of Example 33, further comprising: receiving, from the user, an identification of an EV; and associating the digital signature with the EV.

Example 35. The method of Example 33, further comprising associating the digital signature with an environment of a device of the EVSPS.

Example 36. The method of Example 33, further comprising: identifying the user; and associating the digital signature with the user.

Example 37. The method of Example 33, further comprising: receiving, from the user, an indication of a payment method; and associating the digital signature with the payment method.

Example 38. The method of Example 33, wherein the base set of discrete signals is generated by removing excursions from an initial set of discrete signals.

Example 39. The method of Example 33, wherein generating the base set of discrete signals using the one or more digital signals comprises filtering out local ambient noise from the one or more digital signals.

Example 40. The method of Example 33, wherein the mode comprises one of an optimal cost mode, a rapid charge mode, a battery maintenance mode, and a wait mode.

Example 41. The method of Example 33, wherein the digital signature comprises a base and an envelope.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Descriptions is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

At least some embodiments may comprise a computer program product including a computer-readable storage medium having stored instructions and/or data thereon that may be used to program a computer (or other electronic device) to perform processes described herein. The computer-readable storage medium comprises at least a non-transient storage medium, such as, e.g., a hard drive, a fixed disk, a removable disk, a floppy diskette, an optical disk, a CD-ROM, a CD-RW, a DVD-ROM, a DVD-RW, a read-only memory (ROM), a random access memory (RAM), an erasable programmable ROM (EPROM), an electrically erasable programmable ROM (EEPROM), a magnetic card, an optical card, a solid-state memory device, or other types of media/machine-readable media suitable for storing electronic instructions and/or data.

It is recognized that any standard operating systems may be used may be used on devices disclosed herein (e.g., in conjunctions with the hardware of such devices), such as, for example, Microsoft® Windows®, Apple® MacOS®, Disk Operating System (DOS), UNIX, IRJX, Solaris® SunOS®, FreeBSD, Linux®, ffiM® OS/2® operating systems, and so forth.

A software module, module, or component may include any type of computer instruction or computer executable code located within a memory device and/or computer-readable storage medium, as is well-known in the art.

The modules, components, and/or facilities disclosed herein may be implemented and/or embodied as a driver, a library, an interface, and API, FPGA configuration data, firmware (e.g., stored on an EEPROM or similar device), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGA(s), ASIC(s), and/or the like.

It will be obvious to those having skill in the art that many changes may be made to the details of the above described embodiments without departing from the underlying principles of the invention. The scope of the present invention should, therefore, be determined only by the following claims.

1. A server of an electric vehicle service provisioning system (EVSPS), comprising:
one or more processors, and
a memory comprising:
a cataloged digital signature; and
instructions that when executed by the one or more processors, configure the server to:
receive, from a microphone-enabled device of the EVSPS, a waveform corresponding to a voice command;
process the waveform into a digital signature;
determine a mode for charging an electric vehicle (EV) based on a comparison of the digital signature to the cataloged digital signature; and
send an instruction to an electric vehicle supply equipment (EVSE) to charge the EV according to the mode.

2. The server of claim 1, wherein the memory further comprises instructions that, when executed by the one or more processors, configure the server to:
identify a user that provided the voice command; and
determine that the user is authorized to charge the EV according to the mode.

3. The server of claim 1, wherein the memory further comprises instructions that, when executed by the one or more processors, configure the server to determine whether an environment corresponding to the digital signature matches an environment of the microphone-enabled device.

4. The server of claim 1, wherein the microphone-enabled device is the EVSE.

5. The server of claim 1, wherein the microphone-enabled device is an EVSE remote panel.

6. The server of claim 1, wherein the voice command identifies the EV.

7. The server of claim 1, wherein the mode for charging comprises one of an optimal cost mode, a rapid charge mode, a battery maintenance mode, and a wait mode.

8. The server of claim 1, wherein:
the cataloged digital signature is associated with a payment method to use to pay for the charging of the EV according to the mode; and
the instructions, when executed by the one or more processors, further configure the server to authorize the use of the payment method to pay for the charging of the EV according to the mode.

9. A device of an electric vehicle service provisioning system (EVSPS), comprising:
one or more microphones;
one or more processors; and
a memory comprising instructions that, when executed by the one or more processors, configure the device to:
receive audio comprising a voice command from a user on the one or more microphones;
generate a waveform based on the voice command; and
send the waveform to a server of the EVSPS.

10. The device of claim 9, wherein the device comprises an electric vehicle supply equipment (EVSE) of the EVSPS that further comprises:
an electrical connection to an electric power source; and
a service coupling configured to couple to an electric vehicle (EV) and provide power from the electric power source to the EV; and
wherein the memory further comprises instructions that, when executed by the one or more processors, configure the EVSE to:
receive an instruction from the server to charge the EV according to a mode; and
charge the EV according to the mode via the service coupling.

11. The device of claim 10, wherein the memory further comprises instructions that, when executed by the one or more processors, configure the EVSE to determine that the service coupling is coupled to the EV.

12. The device of claim 9, wherein the device comprises an electric vehicle supply equipment (EVSE) remote panel.

13. The device of claim 12, wherein the EVSE remote panel is configured to communicate with an EVSE of the EVSPS.

14. The device of claim 9, wherein the memory further comprises instructions that, when executed by the one or more processors, configure the device to isolate the voice command from the audio.

15. A method of a voice-activated electric service provisioning system (EVSPS), comprising:
receiving audio comprising a voice command of a user;
recording the voice command as a waveform;
processing the waveform into a digital signature;
determining a mode for charging an electric vehicle (EV) by comparing the digital signature to a cataloged digital signature; and
charging the EV according to the mode.

16. The method of claim 15, further comprising:
identifying the user based on the audio; and
determining that the user is authorized to charge the EV according to the mode.

17. The method of claim 15, further comprising determining whether an environment corresponding to the digital signature matches an environment of a device of the EVSPS that receives the audio.

18. The method of claim 15, wherein the audio is received on two or more microphones, and further comprising isolating the voice command from the audio.

19. The method of claim 15, wherein the voice command identifies the EV.

20. The method of claim 15, wherein:
the cataloged digital signature is associated with a payment method to use to pay for the charging of the EV according to the mode; and
further comprising authorizing the use of the payment method to pay for the charging of the EV according to the mode.

21. The method of claim 15, wherein the mode for charging comprises one of an optimal cost mode, a rapid charge mode, a battery maintenance mode, and a wait mode.

22. The method of claim 15, wherein the voice command is received at a remote panel of the EVSPS that is separate from an electric vehicle supply equipment (EVSE) of the EVSPS that performs the charging of the EV.

23. The method of claim 15, further comprising determining that a service coupling of the EVSPS is coupled to the EV.
